(19) United States
(12) Patent Application Publication
(10) Pub. No.: US 2026/0348261 A1
(43) Pub. Date: Nov. 5, 2026

(54) COMPRESSION OF LOW-PRESSURE FUGITIVE HYDROCARBON EMISSIONS BY UTILIZING HIGHER PRESSURE WELL FLUID

(71) Applicant: Peter Paul Electronics Co., New Britain, CT (US)

(72) Inventors: Kostyantyn Partola, New Britain, CT (US); Mark Mangiafico, New Britain, CT (US)

(21) Appl. No.: 19/653,664

(22) Filed: Apr. 21, 2026

Related U.S. Application Data
(60) Provisional application No. 63/792,674, filed on Apr. 22, 2025.

(51) Int. Cl. E21B 43/12; F04B 39/10; F16K 11/00

(52) U.S. Cl. CPC E21B 43/121; F04B 39/10; F16K 19/00

(57) ABSTRACT

A pneumatic gas compressor is described requiring minimal electrical power comprising a vessel that has an interior volume to contain pressurized gases, a movable piston deposed inside the vessel, dividing said vessel into a first chamber and a second chamber, a spring deposed in said first chamber that applies force to a surface of said moveable piston wherein fugitive gas from a gas source is transferred into a discharge flow path.

### CROSS-REFERENCE TO RELATED APPLICATIONS

This application claims priority to U.S. provisional patent application Ser. No. 63/792,694, filed Apr. 22, 2025, which is hereby incorporated by reference in its entirety.

### TECHNICAL FIELD

This application relates to collection and management of fugitive hydrocarbon emissions resulting from oil and gas production.

### BACKGROUND

Fugitive gas emissions from oil and gas wells represent a significant environmental challenge, contributing to climate change, air pollution, and health risks. These emissions, which occur both intentionally and unintentionally from gas extraction and refinement processes, have far-reaching effects on the environment and human health. While natural gas is often considered a cleaner fossil fuel compared to coal and oil, the escape of methane and other volatile organic compounds (VOCs) from gas wells complicates its environmental footprint.

Fugitive emissions from gas wells can occur at various stages of natural gas extraction and transportation, but the most significant releases typically happen during drilling, production, and the infrastructure that connects these operations to the broader energy market. One important source of recurring gas release is from the valves and regulators incorporated into the production and transport equipment. Once gas is extracted, it is often transported from the wellhead and processed at gas processing facilities. Emissions can occur from equipment such as valves, regulators, separators, dehydrators, and storage tanks, sometimes from the breakdown of joints and seals, but also from intentional releases due to bleeding excess gases from properly operating equipment. These releases may go undetected unless systems are in place to monitor and address them proactively.

One important approach to reducing fugitive gas emissions are technological innovations such as methane capture and utilization systems that are becoming increasingly important in mitigating fugitive emissions. Recent legislation is driving the oil and gas industry to capture these emissions and prevent them from entering the atmosphere. Innovations that improve the capture of fugitive gases at various points during the extraction and transportation process and either repurpose it for energy generation or compress it for use in other industrial processes are desirable.

### SUMMARY

This disclosure is directed to the capture and transport of fugitive hydrocarbon emissions (for example, methane) at natural oil and gas wells only requiring minimal electrical power. Such wells incorporate components like valves and regulators that use pneumatic pistons to do work and also vent excess gas to the atmosphere. Many such wells are in remote locations and suffer from a lack of access to substantial electrical power and, instead, must rely on limited electrical supply sources such as batteries or solar power. As a result, compressing such fugitive gas and pumping it into the well's production or sales line is not possible using a typical compressor that requires significant electrical energy. This disclosure presents a solution that uses the pressure differential between the well and the production line, sales line or ambient atmospheric pressure to compress the fugitive emissions into the production or sales line. Compression is accomplished using a specially tuned pneumatic vessel operating by a dynamic process incorporating three repeating stages or “states” and their transitions.

### BRIEF DESCRIPTION OF THE DRAWINGS

Referring to the figures, which are exemplary embodiments, and wherein the like elements are numbered alike:

FIG. 1 shows a diagram depicting a gas well and the above-ground wellhead apparatus in accordance with embodiments of the present disclosure.

FIG. 2 shows a diagram depicting the above-ground wellhead apparatus, including a separator and accumulator, in accordance with embodiments of the present disclosure.

FIG. 3 shows a piping and instrumentation diagram for an embodiment used for pumping fugitive gas from a natural gas wellhead in accordance with embodiments of the present disclosure.

FIG. 4A shows cross-sectional diagram of an embodiment of a pneumatic gas compressor in State-1 configuration of three repeated stages in accordance with embodiments of the present disclosure.

FIG. 4B shows cross-sectional diagram of an embodiment of a pneumatic gas compressor in the transition between State-1 and State-2 configurations in accordance with embodiments of the present disclosure.

FIG. 4C shows cross-sectional diagram of an embodiment of a pneumatic gas compressor in State-2 configuration in accordance with embodiments of the present disclosure.

FIG. 4D shows cross-sectional diagram of an embodiment of a pneumatic gas compressor in the transition between State-2 and State-3 configurations in accordance with embodiments of the present disclosure

FIG. 4E shows cross-sectional diagram of an embodiment of a pneumatic gas compressor in State-3 configuration in accordance with embodiments of the present disclosure.

FIG. 4F shows cross-sectional diagram of an embodiment of a pneumatic gas compressor that has returned to in State-1 configuration in accordance with embodiments of the present disclosure.

FIG. 5 shows plots of the superimposed gas pressure profiles for chamber A and Chamber B functions of time for a pneumatic gas compressor in State-3 configuration in accordance with embodiments of the present disclosure.

FIG. 6 shows a flow diagram depicting the key actions of a controller embodiment governing the action of the pneumatic gas compressor in accordance with embodiments of the present disclosure.

FIG. 7 shows a plot of measured pressure data from a pneumatic gas compressor test implementation in accordance with embodiments of the present disclosure.

FIG. 8 shows an embodiment incorporating two pneumatic gas compressor sections operating in parallel in accordance with embodiments of the present disclosure.

### DETAILED DESCRIPTION

One goal of the oil and gas industry today is to achieve cleaner operation and lower carbon footprint. An important part of this objective is to capture fugitive hydrocarbon emissions (for example, methane) at natural oil and gas wells. Oil and gas wells use pneumatic pistons to do work, and it is common practice to vent discharge from such components into the atmosphere.

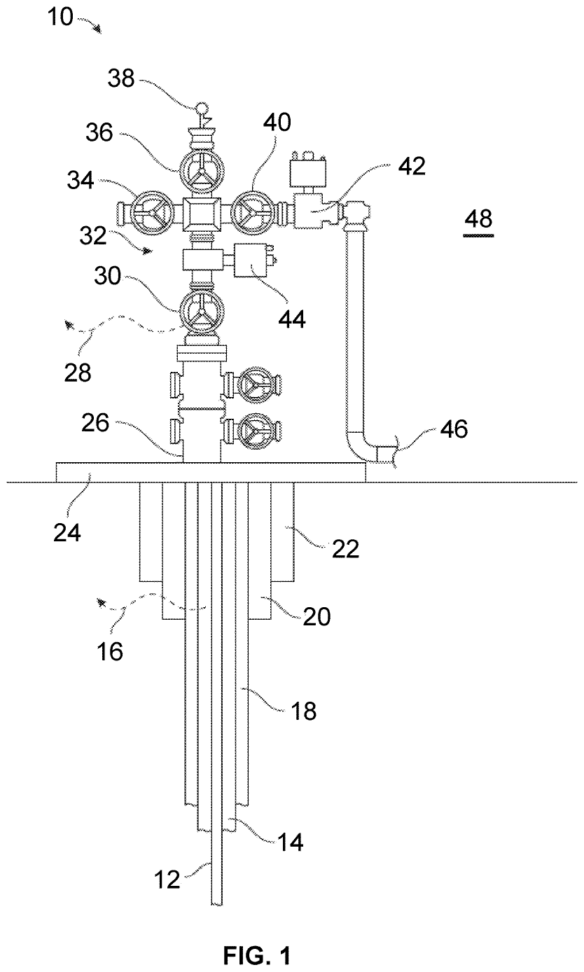

FIG. 1 illustrates the main components of a gas well pad 10 used to extract subsurface natural gas and methane and prepare it for transport to a facility for sale or further processing. Downhole gas travels from a ground substrate level up the well tube 12 to the well pad 24 at the surface. Surrounding the well tube 12 are several concentric structures including the intermediate casing 14, conductor casing 20 and surface casing 18 which, near the surface, is enclosed in cement 22. Fugitive gas 16 can diffuse through these material structures to rise to the surface, and can also simply be leaked into the ground surround the downhole well through joints and seals. Fugitive gas from all these structures can migrate to the surface and through the well pad 24 over time, ultimately to be released into the atmosphere 48.

In the discussion that follows, the gas leaving the wellhead flows through tubing (equivalently, pipe or conduit) called the production line. In some configurations, this conduit may be a sales line—that is, a conduit for the purpose of delivering gas to a customer. In other applications, the production line may convey gas output for further downstream processing. For convenience and without implying limitation in the present disclosure or claims, the terms “production line” and “sales line” will be used interchangeably without regard to the purpose of the output conduit in any particular application or configuration.

A second important source of fugitive emissions from the wellhead are the joints and seals formed when components of the wellhead tree 32 and production line 46 are joined together. Over time, these joints and seals may degrade and leak fugitive gas 28 into the atmosphere 48. Example components of a typical wellhead tree 32 include the casing hanger 26, the upper master valve 30, the master valve 44, the kill wing valve 34, the wing valve 40, the swab valve 36, the choke valve 42 and the pressure gauge 38. In fact, a wellhead tree 32 may comprise dozens of components each participating in several joints and seals, which can give rise to many sources of fugitive gas 28 released into the atmosphere 48.

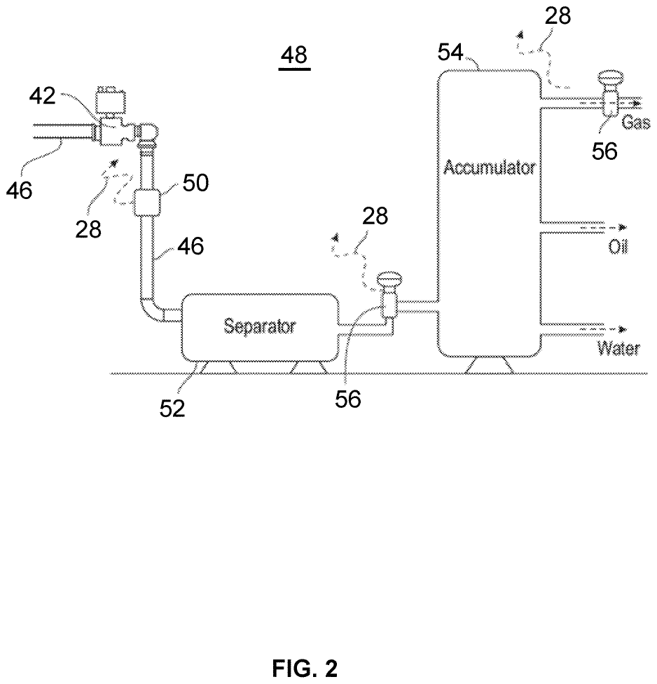

A third critical source of fugitive gas are at the surface of a gas well are components that use gas and may bleed fugitive gas intentionally into the atmosphere 48 as illustrated in FIG. 2. For example, modern backpressure regulators 50 may use pneumatic pistons to adjust flow through an integrated regulator valve 50 (integrated because it contains both valve and pilot assemblies) which are connected to a source of pressurized gas such as natural gas, methane or hydrogen. When the flow demand changes through upstream components like the choke valve 42, adjustments to the regulator may require bleeding some excess (fugitive) gas 28 as exhaust. Although different regulator designs exist, it is common to release the exhaust gas through a device exhaust port into the atmosphere 48.

Downstream of the wellhead tree (not shown) and the production line 46 may be separators 52, accumulators 54 and storage tanks that comprise elements of the transport and production process. Dump valves 56 may be interspersed between downstream components as elements of pressure relief systems, allowing for the rapid release of excess pressure in emergency situations, protecting equipment from damage. Dump valves may also be used to quickly and safely discharge liquid (like water or condensate) and gas from production vessels (like separators or other treaters) to maintain desired gas pressures and liquid levels, thereby preventing potential issues like corrosion or equipment damage. Discharges from dump valves may also release fugitive gas 28 into the atmosphere.

Historically, it has been common to release dump valve discharges and bleed exhaust gas into the atmosphere 48. Indeed, by some industry estimates suggest that the release of fugitive gases by wellhead valve and regulator bleed exhausts, leaks and faulty seals may constitute over 60% of the total released fugitive gas emission into the atmosphere 48 on an annual basis.

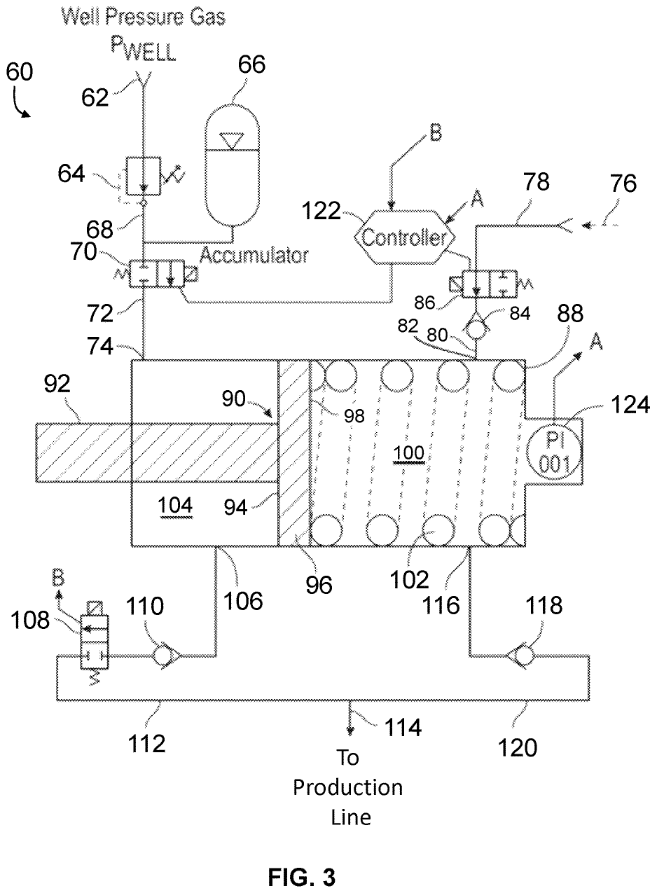

FIG. 3 shows a piping and instrumentation diagram (P&ID) illustrating an embodiment for a pneumatic gas compressor 60 of the present disclosure that uses the difference between the wellhead tubing pressure and a fugitive gas stream (e.g., exhaust from a dump valve or regulator as shown in FIG. 1 or FIG. 2) pressure to pneumatically compress (equivalently, pump) the fugitive gas into the production line, thereby creating a pneumatic gas compressor. Production gas (the gas drawn up the well tubing from the subsurface deposit) at the well pressure, P_{WELL}, typically between 2,000 pounds per square inch (psi) and 20,000 psi, enters through a conduit 62 to a regulator 64 that substantially maintains a constant pressure. Well gas may enter an accumulator 66 or other element of the transport and production system. Gas from the regulator 64 flows through a conduit 68 to an inlet control valve 70. Well gas from the inlet control valve 70 is directed through a conduit 72 to an inlet 74 of a vessel 88. The vessel 88 is separated into two chambers, chamber A 100 and chamber B 104 by a piston assembly 90. The well gas from the inlet control valve 70 flows through the conduit 72 and inlet 74 to the interior of chamber B 104. The piston assembly 90 comprises a shaft 92 and a base 96 and is longitudinally movable along the length of the vessel 88. The moveable piston base 96 has two surfaces, one surface 98 that faces into the interior of chamber A 100 and an opposing surface 94 that faces into the interior of chamber B 104. A spring 102 that may span part or all of chamber A 100 longitudinally exerts a force on the surface 98 of the piston base 96 facing the interior of chamber A 100 whenever the piston 90 is positioned to distend the spring 102 from its nominal position. The spring 102 may be located either inside the vessel as shown or, equivalently, outside the vessel (not shown) exerting a force on the piston 94, say, by exerting a force directly on the piston 94 shaft 92. Equivalently, the spring may be located either within chamber A 100 (as shown) applying a force on a surface 98 of the piston base 96 facing the interior of chamber A or, alternatively, within chamber B 104 applying a force on a surface 94 of the piston base 96 facing an interior of chamber B 104.

Fugitive gas—for example, as exhaust from a dump, regulator or pressure valve (not shown)—enters 76 an inlet control valve 86 and check valve 318 through a conduit 78. Gas flow through the inlet control valve 86 passes through a check valve 84 and enters the vessel 88 through an inlet 82 to the interior of chamber A 100. The exhaust gas pressure typically isn't constant, but varies between a low pressure, P_{MINF}, and a high pressure, P_{MAXF}.

Gas may leave chamber A 100 through an outlet 116 disposed on the vessel 88 through a check valve 118 and a conduit 120 to the production line 114. Similarly, gas may leave chamber B 104 through an outlet 106 disposed on the outer surface of the vessel 88. From the outlet 106, the gas enters an outlet check valve 110 and an outlet (alternatively, exhaust) control valve 108 combination to a conduit 112 and into the production line 114.

Exemplary embodiments show the vessel shape as a right-circular cylinder. The present disclosure also contemplates embodiments where the vessel may have any suitable shape and may each independently have a circular cross-sectional shape, an elliptical cross-sectional shape, an oval cross-sectional shape, a stadium cross-sectional shape, a semicircular cross-sectional shape, a square cross-sectional shape, a rectangular cross-sectional shape, a triangular cross-sectional shape, or combination thereof. A right circular cylinder is specifically mentioned.

Exemplary embodiments show the spring disposed in the interior of chamber A and in contact with a surface of the movable piston facing the interior of chamber A. The present disclosure also contemplates embodiments where the spring is disposed in the interior of chamber B or disposed on the outside of the vessel. Indeed, the important defining functional characteristic of the spring is that it is arranged to provide a force acting on the piston that is approximately proportional to the displacement of the piston from a design nominal position.

Actions of the well gas inlet control valve 70, the fugitive gas inlet control valve 86, and the well gas outlet control valve 108 are modulated by a controller 122 informed by measurements from one or more sensors 124 disposed in or on chamber A 100. Sensors 124 located in chamber A 100 may be simple pressure sensors as shown in FIG. 3, or a sensor combination such as pressure sensor and a piston position sensor providing both pressure and piston displacement measurements to the controller 122.

A first feature of embodiments in the present disclosure is that the pneumatic gas compressor for fugitive gas requires only minimal access to electrical power supplied, for example, merely by battery or solar power sources. The inventors have discovered a means for pneumatic gas transport from a source device to the sales line of a well utilizing the difference in regulated operating pressures of the well, sales line and source device exhaust as the primary source of compressive force.

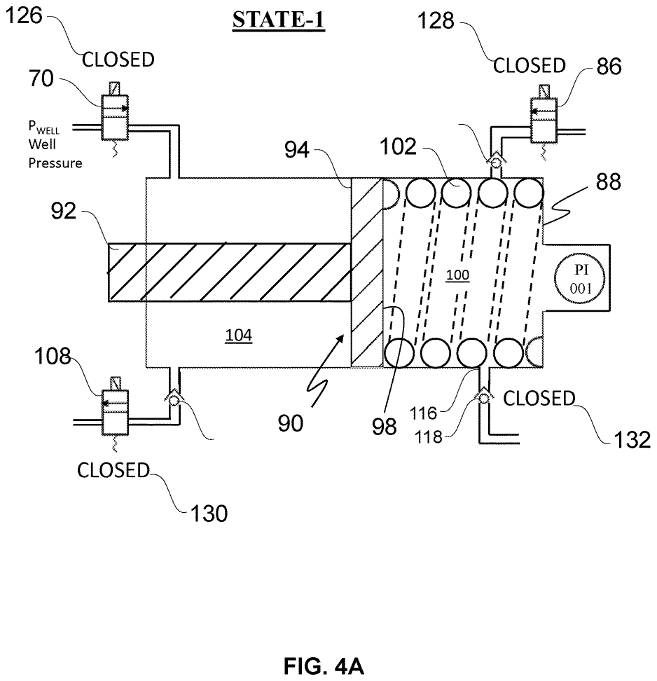

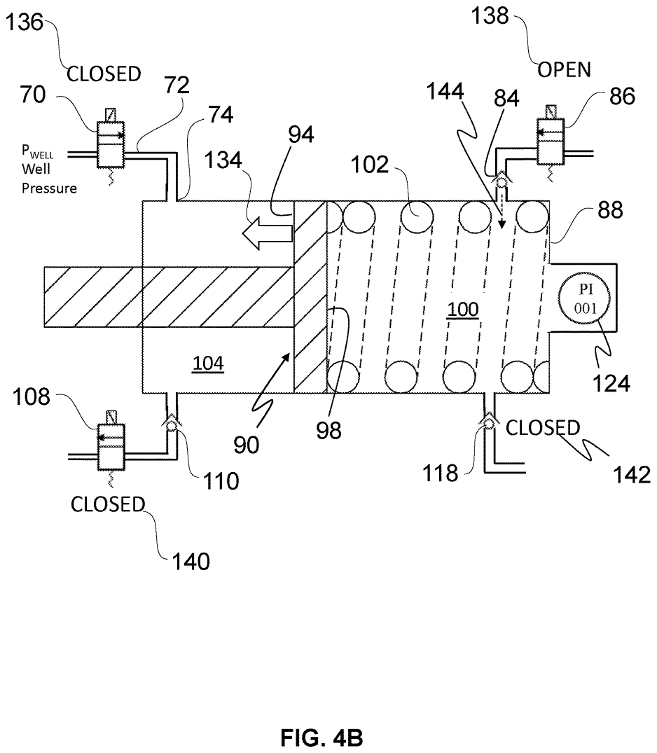

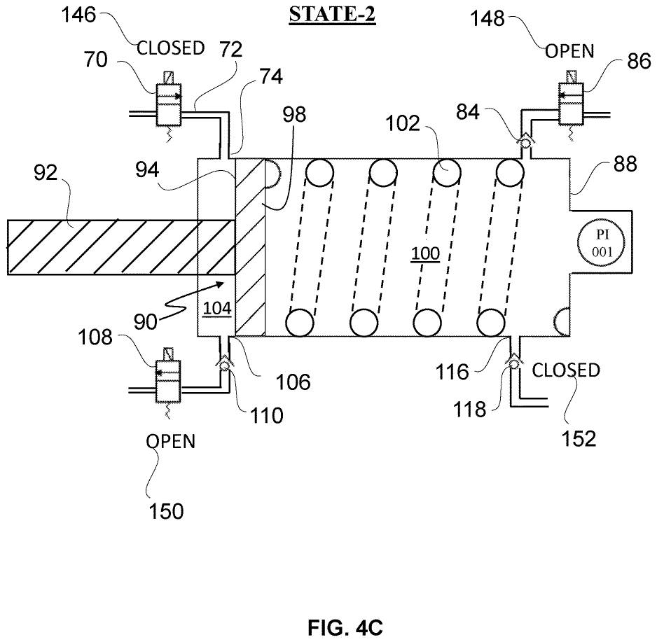

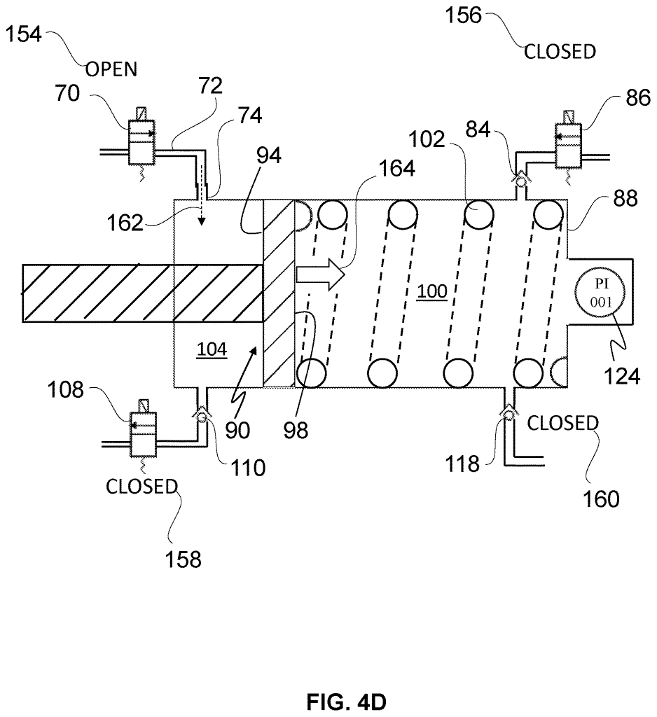

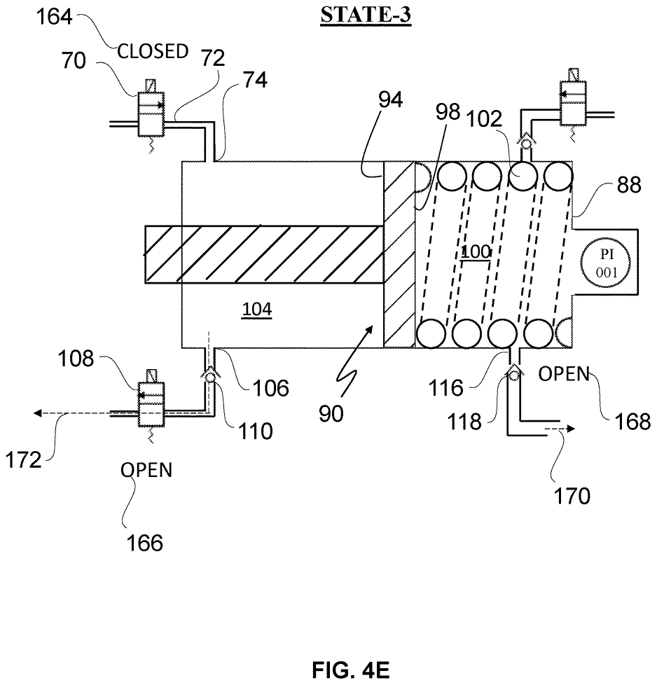

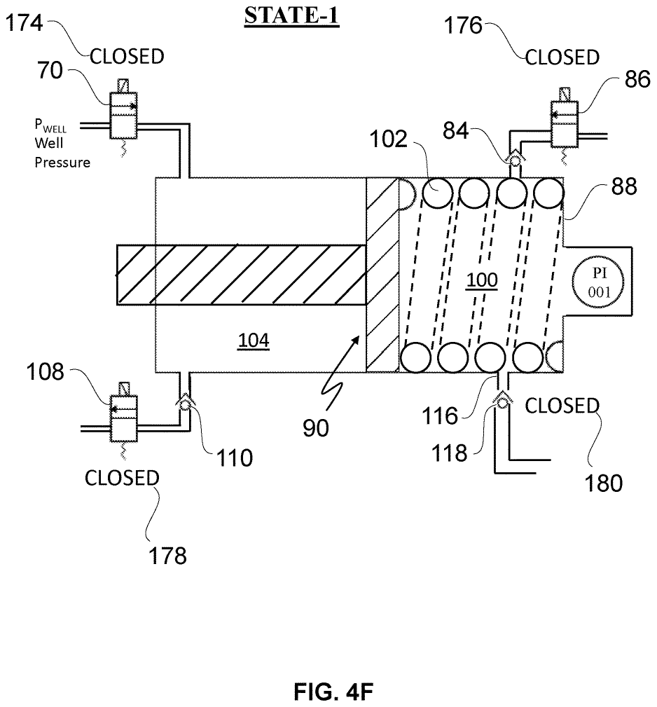

The operation of the pneumatic gas compressor is illustrated in FIG. 4A, FIG. 4B, FIG. 4C, FIG. 4D, FIG. 4E and FIG. 4F. The dynamics of an embodiment of the pneumatic gas compressor is that of a forced oscillator passing through a repeating cycling sequence of three “States”—denoted as State-1, State-2 and State-3—separated by a transition phases. For the discussion below, let P_{A}(t) and P_{B}(t) denote the gas pressures in chamber A and chamber B, respectively, at time t>0. For convenience we adopt the notation that at a particular time, tᵢ≥0, 1≤i≤3, where the system is in State-i, the pressures in chamber A and chamber B may be denoted P_{Ai} and P_{Bi}. For example, P_{A1} and P_{B1} represent gas pressures for chamber A and chamber B, respectively, each time the pneumatic gas compressor is in the State-1 configuration.

An important relationship governing the various line pressures required for an embodiment to repeatedly cycle through each of the states is,

P_{WELL}>P_{SL}>P_{MAXF}>P_{MINF}
where P_{WELL} is the well pressure, P_{SL} is the sales line (equivalently, production line) pressure, and P_{MAXF} and P_{MINF} are the maximum and minimum pressures, respectfully, of the gas in chamber A as exhausted by a device connected to the control valve 86 as shown in FIG. 4A. Typically, the sales (equivalently, production line) pressure is between 50 psi and 5,000 psi.

The configuration of an embodiment associated with State-1 is shown in FIG. 4A, the configuration with the spring 102 fully contracted in the vessel 88 after discharging as much fugitive gas from chamber A 100 through the outlet 116 and past the exhaust valve 118 associated with chamber A 100. The exhaust valve 118 may be a check exhaust valve, a pressure relief exhaust valve with a setpoint value set at the sales (production) line pressure, P_{SL}, a control exhaust valve or another type of valve as required by the type of controller 122 implemented and the application pressure constraints. The exemplary embodiment of FIG. 3 illustrates the use of a check valve 118 (alternatively, check exhaust valve). Since this configuration exhibits the lowest gas pressure in chamber A 100, P_{A1}=P_{MINF}. The piston 90 is instantaneously stationary at one limit of its motion inside the vessel 88 with the piston shaft 92 fully extended. The control valve 70 exposing chamber B 104 to the well gas is CLOSED 126, and the control valve 108 releasing gas into the production line through a check valve 110 and control valve 108 combination is CLOSED 130. The control valve 86 and check valve 84 exposing chamber A 100 to fugitive gas for a device are CLOSED 128 and the check valve 118 through which fugitive gas passes from chamber A 100 through the outlet in the vessel 88 is CLOSED 132. As a result, in the State-1 configuration, P_{B}1=P_{SL}, where P_{SL} is the gas pressure in the sales line since gas in chamber B has already been released into the production (alternatively, sales) line. If the surface area 98 of the piston 90 base facing the interior of chamber A 100 is denoted A_{A} and the surface area 94 of the piston 90 base facing the interior of chamber B 104 is denoted A_{B}, then the force acting on the piston can be computed to be:

F_{S1}=P_{B1}A_{B}−P_{A1}A_{A},

where F_{S1} is the force acting on the surface of the piston 321 base in the State-1 configuration due to gas pressure. Importantly, notice that the ratio, A_{A}/A_{B}, is proportional to the mechanical leverage created by the piston applying pneumatic force from one chamber upon the other. Thus, one skilled in the art of compressor design can use the well pressure, P_{WELL}, production line pressure, P_{SL}, surface areas of the piston base, A_{A} and A_{B}, and spring constant, k, to define the key mechanical parameters for a specific embodiment of the pneumatic fugitive gas compressor. Other parameters, such as the piston 90 stroke length and the vessel length depend upon details of the application and footprint requirements. Since the same fundamental principles apply, pneumatic gas compressor designs in accordance with embodiments of the present disclosure are applicable to a wide range of gas, pressure, conduit sizes and vessel dimensions. Applications for pneumatic gas compressor designs both in and outside the oil and gas industry in accordance with embodiments of the present disclosure may utilize sources in fluid communication with the chamber B inlet control valve 70 from 1 psi to 100,000 psi. The gas pressure range greater than or equal to 2,000 psi to less than or equal to 20,000 psi is specifically mentioned.

For contemplated applications in the oil and gas industry, the surface area of the piston facing the interior of chamber A will be greater than zero square inches (in²) and less than or equal to 102,000 in², while the surface area of the piston facing the interior of chamber B will be greater than zero square inches (in²) and less than or equal to 102,000 in² with A_{A}>A_{B} for any particular embodiment. The range comprising A_{A} greater than or equal to 0.05 in² and less than or equal to 102,000 in² is specifically mentioned. The range comprising A_{B} greater than or equal to 0.05 in² and less than or equal to 102,000 in² is specifically mentioned.

FIG. 4B shows an embodiment of the pneumatic gas compressor in transition between State-1 and State-2. The control valve 70 connected to the inlet 74 of chamber B 104 through a conduit 72 is CLOSED 136. The control valve 108 and check valve 110 connecting chamber B 104 to the production line are also CLOSED 140. The piston 90 is moving in the vessel 88 under the force 134 of the spring 102 to compress the gas in chamber B 104 as fugitive exhaust gas 144 is admitted into chamber A 100 from the device connected to the control valve 86 and through the OPEN 138 associated check valve 84. The check valve 118 to the chamber A 100 fugitive gas exhaust is CLOSED 142. During this transition phase, the force 134 acting on the piston 90 base is a time-varying decreasing function given by,

Fs(t)=P_{B}(t)·A_{B}−P_{A}(t)·A_{A},

where A_{A} is the area of the piston surface 98 facing the interior of chamber A 100 and A_{B} is the area of the piston surface 94 of the facing the interior of chamber B 104. The sensor(s) 124 exposed to the interior of chamber B 104 may register the pressure P_{B}(t) and/or piston 90 displacement in chamber B 104.

FIG. 4C shows an embodiment of the pneumatic gas compressor in the configuration associated with State-2, a configuration where the spring 102 is fully extended in the vessel 88 chamber A 100 which has been filled with fugitive gas from the device through the inlet past the control valve 86 and check valve 84 associated with chamber A 100. Since this configuration exhibits the highest gas pressure in chamber A 100, P_{A1}=P_{MAXF}. The piston 90 is instantaneously stationary at the limit of its motion inside the vessel 88 with the spring 102 fully extended and the piston shaft 92 fully retracted. The control valve 70 exposing chamber B 104 to the well gas through a conduit 72 and into an inlet 74 in the vessel 88 is CLOSED 146, and the control valve 108 and check valve 110 combination releasing gas into the production line through outlet 106 is OPEN 150. The control valve 86 exposing chamber A 100 to fugitive gas is OPEN 148, and the check valve 118 releasing fugitive gas into the production line through an inlet 116 is CLOSED 152. As a result, in the State-2 configuration, P_{B}2=P_{SL}, where P_{SL} is the gas pressure in the sales (alternatively, production) line, and P_{A2}=P_{MAXF}, the maximum pressure achieved in chamber A 100 throughout the compression cycle. If the surface area 98 of the piston 90 base is denoted A_{A} and the surface area 94 of the piston 90 base is denoted A_{B}, then the force acting on the piston is computed to be:

F_{S2}=P_{B2}·A_{B}−P_{A2}·A_{A},

where F_{S2} is the force acting on the surface of the piston 90 base in the State-2 configuration due to gas pressure.

FIG. 4D shows an embodiment of the pneumatic gas compressor in transition between State-2 and State-3. The control valve 70 connected to the inlet 74 of chamber B 104 through a conduit 72 is OPEN 154. The control valve 108 and check valve 110 connecting chamber B 104 to the production line are also CLOSED 158. The piston 90 is moving in the vessel 88 under the force 164 of the spring 102 to compress gas in chamber A 100 as well gas 162 is admitted into chamber B 104 from the wellhead. The control valve 86 and check valve 84 combination admitting fugitive gas into chamber A is CLOSED 156, and the check valve 118 releasing fugitive gas into the production line is CLOSED 160. During this transition phase, the force 164 acting on the piston 90 base is a time-varying increasing function given by,

Fₛ(t)=P_{B}(t)·A_{B}−P_{A}(t)·A_{A},

where A_{A} is the area of the piston surface 98 facing the interior of chamber A 100 and A_{B} is the area of the piston surface 94 of the facing the interior of chamber B 104. The sensor(s) 124 exposed to the gas in chamber A 100 may register the pressure P_{A}(t) and/or piston 90 displacement in chamber A 100.

FIG. 4E shows an embodiment of the pneumatic gas compressor in the configuration associated with State-3, a configuration with the spring 102 fully contracted in the vessel 88 when chamber B 104 has been filled with well gas through the control valve 70 and the conduit 72 to the inlet 74. Since this configuration exhibits the highest gas pressure in chamber B 104, P_{B3}=P_{WELL}. The piston 90 is instantaneously stationary at the limit of its motion inside the vessel 88. The control valve 70 exposing chamber B 104 to the well gas is CLOSED 164. If the surface area 98 of the piston 90 base is denoted A_{A} and the surface area 94 of the piston 90 base is denoted A_{B}, then the force acting on the piston can be computed to be:

F_{S3}=P_{B3}·A_{B}−P_{A3}·A_{A},

where F_{S3} is the force acting on the surface of the piston 90 base in the State-3 configuration.

Finally, in a two-step process, gases in chamber A and chamber B are discharged. First, pressure in chamber A 100 causes the check valve 118 associated with the chamber A outlet conduit inlet 116 to OPEN 168, permitting fugitive gas in chamber A 100 to be discharged 170 to the production line. Second, the control valve 108 associated with the outlet conduit 106 for chamber B 104 is OPENed 166, and with positive pressure causing the check valve 110 to be in its open state, compressed well gas in chamber B 104 is be discharged 172 to the production line.

Once the well gas in chamber B 104 and the fugitive gas in chamber A 100 have been discharged to the sales line, the embodiment configuration has been returned to State-1. The configuration of an embodiment associated with State-1 at the end of a pneumatic compression cycle is shown in FIG. 4F. As before, the configuration corresponds to the spring 102 fully contracted in the vessel 88. Since this configuration exhibits the lowest gas pressure in chamber A, P_{A1}=P_{MINF}. The piston 90 is instantaneously stationary at one limit of its motion inside the vessel 88. The control valve 70 exposing chamber B 104 to the well gas is CLOSED 174, and the control valve 108 and check valve 110 combination releasing gas into the sales line is CLOSED 178. The control valve 86 and check valve 84 combination exposing chamber A 100 to fugitive gas is CLOSED 176, and the check valve 118 through which fugitive gas passes from chamber A 100 through the outlet 116 in the vessel 88 is CLOSED 180. As before, in the State-1 configuration, P_{B1} is equal to P_{SL}, where P_{SL} is the gas pressure in the sales line.

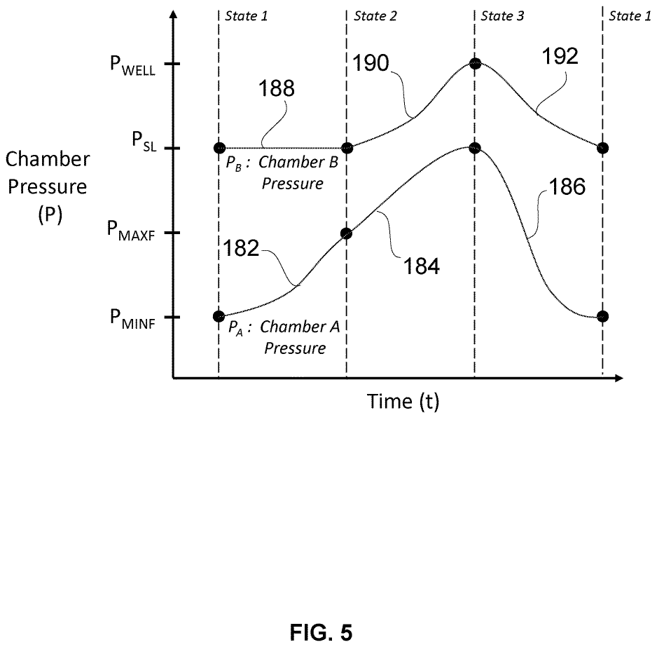

FIG. 5 shows an idealized plot of gas pressures in chamber A and chamber B through the various stages of the pneumatic gas compression cycle as described above. In State-1, the chamber A pressure P_{A}1=P_{MINF}, while the chamber B pressure P_{B}1=P_{SL}. During the transition for State-1 to State-2, the chamber B pressure, P_{B}(t) is constant 188, while the chamber A gas pressure rises 182 from P_{MINF} to P_{MAXF} resulting in P_{B}2=P_{SI} and P_{A2}=P_{MAXF}. During the transition from State-2 to State-3, chamber B is exposed to well gas at a pressure of P_{WELL}, so the gas pressure 190 in chamber B rises from P_{SL} to P_{WELL}, resulting in P_{B3}=P_{WELL}. Likewise, during the transition from State-2 to State-3, P_{A}(t) rises 184 from P_{MAXF} to P_{SL}, ending the transition with P_{A2}=P_{SL}. When the pneumatic compressor is in the transition between State-3 back to State-1, the chamber B pressure, P_{B}, returns 192 to the sales line pressure, P_{B}(t)=P_{SL}, while the pressure in chamber A, P_{A}(t), decreases 186 to end with P_{A3}=P_{MINF}. Once the gases in chamber A and chamber B are exhausted to the sales line, the configuration of an embodiment returns to the conditions present in State-1, namely that P_{A1}=P_{MINF} and P_{B1}=P_{SL} in preparation for the next pneumatic cycle.

A second feature of embodiments in the present disclosure is that the pneumatic gas compressor for fugitive gas is that the design parameters may be expressly determined from known specifications of the wellhead hardware and operating conditions. In particular, given the known pressures at each of the three pneumatic gas compression states—State-1, State-2 and State-3—a design space can be determined for selecting the spring constant, k, and the areas of the two piston surfaces, A_{A} and A_{B}, exposed to gas pressures in chamber A and chamber B. Within this design space, k, A_{A} and A_{B} can be selected that also meet other product criteria, such as constraints on the physical dimensions of the pneumatic gas compressor and the volumes of chambers A and B.

Since the regulated well pressure is higher than the device fugitive gas source pressures, choosing the piston area A_{A} associated with the chamber A side of the piston base to be greater than the piston area A_{B} associated with the chamber B side of the piston base provides mechanical leverage:

A_{A}>A_{B}.

The discussion above uses the relationship between the line pressures that defines the compression cycle states,

P_{WELL}>P_{SL}>P_{MAXF}>P_{MINF}
and the relationship between the magnitude of the forces acting on the spring by the piston at each state,

F_{S3}>F_{S1}>F_{S2}.

Algebraic substitution then provides two competing criteria for defining the design space for the surface areas, A_{A} and A_{B}:

P_{B3}·A_{B}−P_{A3}·A_{A}>P_{B1}·A_{B}−P_{A1}·A_{A}>P_{B2}·A_{B}−P_{A2}·A_{A}.

These relations can be used to determine two inequality expressions for the ratios of the surface areas, A_{A} and A_{B}. The first is found by using the condition F_{S3}>F_{S2} and simple substitution and reduction:

F_{S3}>F_{S2}

P_{B3}·A_{B}−P_{A3}·A_{A}>P_{B2}·A_{B}−P_{A2}·A_{A}

P_{WELL}·A_{B}−P_{SL}·A_{A}>P_{SL}·A_{B}−P_{MAXF}·A_{A}

P_{WELL}·A_{B}−P_{SL}·A_{B}>P_{SL}·A_{A}−P_{MAXF}·A_{A}

A_{B}(P_{WELL}−P_{SL})>A_{A}(P_{SL}−P_{MAXF})
which results in the relation between two ratios,

$$\frac{{A}_{B}}{{A}_{A}} > \frac{{P}_{SL} - {P}_{MAXF}}{{P}_{WELL} - {P}_{SL}} .$$

Conversely, working with the second of the two inequalities above:

F_{S3}>F_{S1}

P_{B3}·A_{B}−P_{A3}·A_{A}>P_{B1}·A_{B}−P_{A1}·A_{A}

P_{WELL}·A_{B}−P_{SL}·A_{A}>P_{SL}·A_{B}−P_{MINF}·A_{A}

P_{WELL}·A_{B}−P_{SL}·A_{B}>P_{SL}·A_{A}−P_{MINF}·A_{A}

A_{B}(P_{WELL}−P_{SL})>A_{A}(P_{SL}−P_{MINF})
which results in the relation between the ratios,

$$\frac{{A}_{B}}{{A}_{A}} > \frac{{P}_{SL} - {P}_{MINF}}{{P}_{WELL} - {P}_{SL}} .$$

In fact, the second inequality dominates the first,

$$\frac{{A}_{B}}{{A}_{A}} > \frac{{P}_{SL} - {P}_{MINF}}{{P}_{WELL} - {P}_{SL}} > \frac{{P}_{SL} - {P}_{MAXF}}{{P}_{WELL} - {P}_{SL}}$$

and imposes the critical constraints on the design space for the ratio of the two piston surface areas, A_{A} and A_{B}. Applying the product specification objects for the dimensions of the vessel, piston and operating pressures, a spring constant, k, is selected that permits the pneumatic gas compressor to all three operating states, State-1, State-2 and State-3.

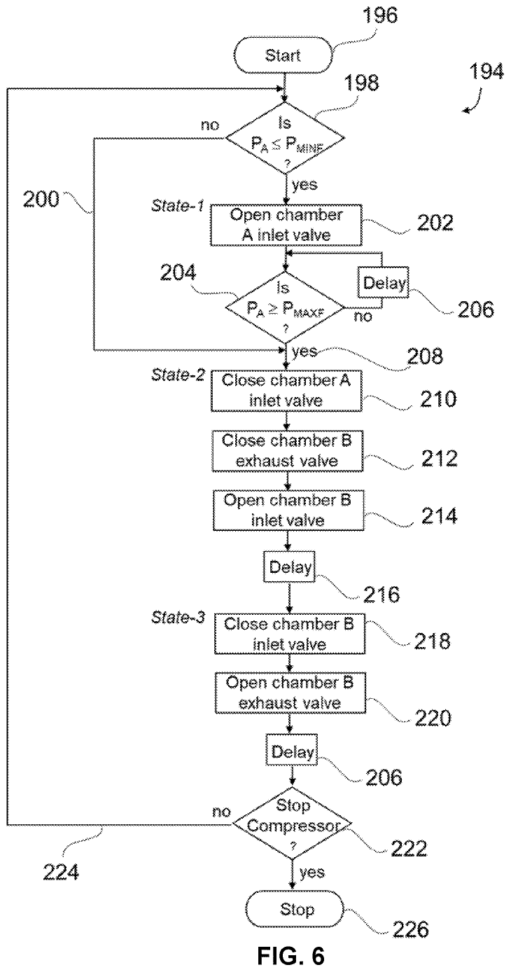

Not intending to be limited by theory, the transitions between the three states (State-1, State-2 and State-3) of the pneumatic gas compressor may be governed by a controller 122 shown in FIG. 3. Controllers contemplated by the present disclosure may incorporate algorithms and methods of any appropriate type including, but not limited to, ON-OFF control, open loop control, closed loop control, feedback control, feed-forward control, proportional control, proportional-integral-derivative (PID) control, model-predictive control, active control, autonomous control, reinforcement learning (RL) control, and artificial intelligence (AI) control. In exemplary embodiments, the controller may be mechanical, electrical or electronic. FIG. 6 shows an algorithm flow diagram 194 depicting the key logical elements of an exemplary embodiment for a feedback controller utilizing one or a plurality of sensors measuring conditions in chamber A of the pneumatic gas compressor vessel. Control is initiated 196 by measuring the pressure, P_{A}, in chamber A and comparing 198 the measured value of P_{A} against a control setpoint, P_{MINF}, for the minimum chamber A pressure. If P_{A}≤P_{MINF} is true, then the chamber A inlet valve 86 is opened 202. Alternatively, if P_{A}>P_{MINF} then a compressor recovery cycle is initiated 200 to setup the conditions for State-1.

Once P_{A}≤P_{MINF}, the State-1 conditions are satisfied and the chamber A inlet valve 86 is opened 202 and the chamber A pressure, P_{A}, approaches its controller setpoint maximum, P_{MAXF}. Until the P_{MAXF} setpoint pressure is reached, the controller introduces a short delay 206. Once chamber A is filled with fugitive gas to a measured pressure at least equal to P_{MAXF} 204 so that P_{A}>P_{MAXF} 208, the chamber A inlet valve 86 is closed 210 indicating the compressor has entered the State-2 phase of its compression cycle.

With the State-2 conditions satisfied, the controller closes 210 the chamber A inlet valve 86, ensures the chamber B exhaust valve 108 is closed 212, and opens 214 the chamber B inlet valve 70. Well gas now enters chamber B, increasing the chamber B pressure, P_{B}, and, simultaneously, through the action of the piston 90, driving the fugitive gas trapped in chamber A through the chamber A check valve 118, thereby exhausting the chamber A fugitive gas into the production line 114 at a pressure of P_{SL}. Once chamber A 100 has had sufficient time through a delay 216 (alternatively, a control switch or other actuator) to vent the fugitive gas into the production line 114, the pneumatic compressor enters the State-3 phase of its compression cycle.

In State-3, the controller closes 218 the chamber B inlet valve 70 and opens 220 the chamber B exhaust valve 108 with a delay 206 to provide time to exhaust chamber B. This returns the compressor to its State-1 conditions and, unless the controller receives an instruction to terminate 222, the compressor controller returns 224 to its initial state 198. Once the compressor controller receives a termination instruction 222, the pneumatic compression cycle stops 226 at the end of State-3.

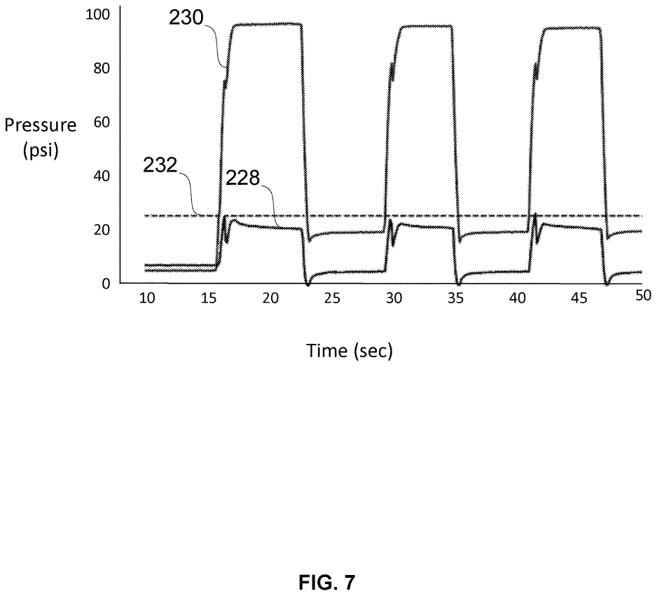

FIG. 7 shows test results measured on a prototype of an embodiment of the pneumatic gas compressor in accordance with embodiments of the present disclosure. Key parameters of the test prototype are provided in TABLE 1.

TABLE 1

| | |
|---|---|
| Well gas pressure, P_{WELL} | 100 psi |
| Sales line pressure, P_{SL} | 25 psi |
| Fugitive exhaust gas pressure | 5 psi |
| Piston area, Chamber A surface, A_{A} | 3.14 square inches |
| Piston area, Chamber B surface, A_{B} | 2.83 square inches |
| Spring constant, k | 23 lbs/inch |
| Cylinder length | 8 inches |
| Stroke | 5.94 inches |

The test prototype was instrumented with pressure sensors in both chambers A and B measuring P_{A}(t) and P_{B}(t), respectively. FIG. 7 displays test results for three complete compression cycles of the pneumatic gas compressor showing data for the chamber A pressure 228 as a function of time and the chamber B pressure 230 as a function of time compared to the sales line pressure, P_{SL} 232. The results show that the prototype embodiment successfully utilizes the pressure difference between the well pressure, P_{WELL}, the fugitive gas pressure, and the sales line pressure, P_{SL}, successfully compresses the low-pressure fugitive gas into the sales line utilizing the higher well gas pressure, P_{WELL}, as the driving force.

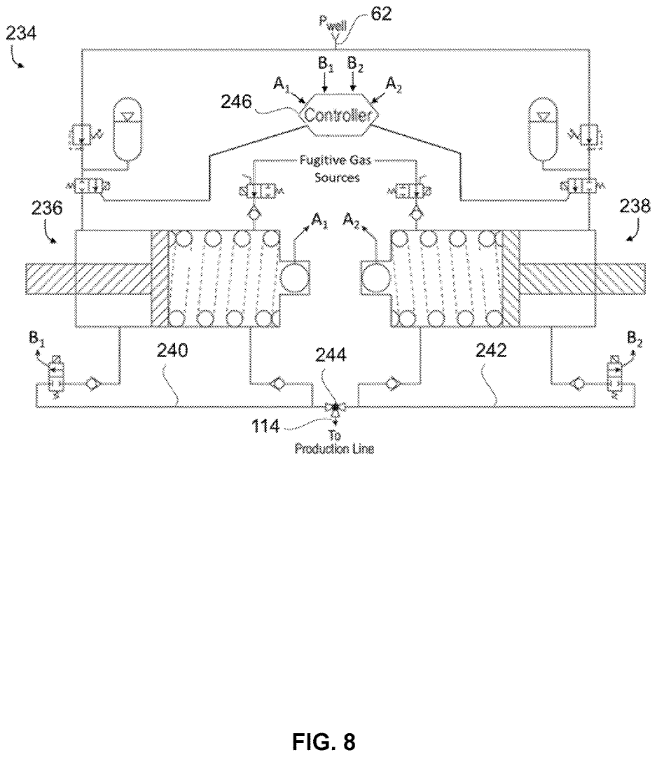

One aspect of the embodiment shown in FIG. 3 and illustrated by the data displayed in FIG. 7 is that the fugitive gas delivered to the sales line is not flowing continuous. That is, during the parts of the pneumatic compression cycle when the piston 90 is recovering and returning to State-1, the chamber A 100 check valve 118 is closed and the device is unavailable to deliver fugitive gas to the production line 114. FIG. 8 shows a composite pneumatic gas compressor 234 embodiment comprising two subsections, each of which are similar to the exemplary embodiment shown in FIG. 3. Two compression sections, a left section 236 and a right section 238, are both in fluidic communication with the wellhead gas line 62 and the production line 114. The exhaust conduit 240 of the left section 236 and the exhaust conduit 242 of the right section 238 enter the production line 114 through a three-way valve 244. A single controller 246 modulates the activity of the control valves of both the left section 236 and the right section 238 using the data, A₁ and A₂, from the pressure sensors of both sections and valve command connections, B₁ and B₂, of both valve sections. Thus, the controller 246 can be programmed to ensure that when one compressor section is in its recovery phase, the other compressor section is in its fugitive gas compression phase, thereby ensuring a more continuous flow of fugitive gas to the production line 114.

Advantageously, the present disclosure provides pneumatic gas compressor devices that provide new, optimized and efficient approaches to driving fugitive gas into the production line of a wellhead structure with minimal electrical requirements.

Although various features have been shown in different figures for simplicity, it should be readily apparent to one of skill in the art that various features may be combined without departing from the scope of the present disclosure.

The foregoing description of embodiments of the present invention has been presented for the purpose of illustration and description. It is not intended to be exhaustive or to limit the invention to the form disclosed. Obvious modifications and variations are possible in light of the above disclosure. The embodiments described were chosen to best illustrate the principles of the invention and practical applications thereof to enable one of ordinary skill in the art to utilize the invention in various embodiments and with various modifications as suited to the particular use contemplated.

The terms “a” and “an” do not denote a limitation of quantity, but rather denote the presence of at least one of the referenced items. The term “or” means “and/or” unless clearly indicated otherwise by context. Reference throughout the specification to “an embodiment”, “another embodiment”, “some embodiments”, and so forth, means that a particular element (e.g., feature, structure, step, or characteristic) described in connection with the embodiment is included in at least one embodiment described herein, and may or may not be present in other embodiments. In addition, it is to be understood that the described elements may be combined in any suitable manner in the various embodiments. “Optional” or “optionally” means that the subsequently described event or circumstance may or may not occur, and that the description includes instances where the event occurs and instances where it does not. The terms “first,” “second,” and the like, “primary,” “secondary,” and the like, as used herein do not denote any order, quantity, or importance, but rather are used to distinguish one element from another. The terms “front”, “back”, “bottom”, and/or “top” are used herein, unless otherwise noted, merely for convenience of description, and are not limited to any one position or spatial orientation.

The endpoints of all ranges directed to the same component or property are inclusive of the endpoints, are independently combinable, and include all intermediate points. For example, ranges of “up to 25 N/m, or more specifically 5 to 20 N/m” are inclusive of the endpoints and all intermediate values of the ranges of “5 to 25 N/m,” such as 10 to 23 N/m.

Unless defined otherwise, technical and scientific terms used herein have the same meaning as is commonly understood by one of skill in the art to which this invention belongs.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

What is claimed is:

1. A pneumatic gas compressor, comprising:
a vessel defining an interior volume;
a movable piston disposed inside the vessel, dividing said interior volume into a first chamber and a second chamber;
a spring disposed in contact with the piston, configured to apply force to a surface of the piston;
a first inlet valve assembly in fluid communication with the first chamber;
a first outlet valve assembly in fluid communication with the first chamber;
a second inlet valve assembly in fluid communication with the second chamber;
a second outlet valve assembly in fluid communication with the second chamber; and
a controller configured to manage operation of one or a plurality of valve assemblies;
wherein the first inlet valve assembly is fluidly connected to a first gas source providing a first gas at a time-varying pressure P_{F} with P_{FMAX}≥P_{F}≥P_{FMIN};
wherein the second inlet valve assembly is fluidly connected to a second gas source at a pressure P_{WELL};
wherein the first outlet valve assembly and second outlet valve assembly are fluidly connected to a common discharge line at a pressure P_{SL}; and
wherein the pressures are configured such that P_{WELL}>P_{SL}>P_{MAXF}>P_{MINF}.

2. The pneumatic gas compressor of claim 1, wherein at least one of the first inlet valve, the first outlet valve, the second inlet valve and the second outlet valve is a control valve in communication the controller.

3. The pneumatic gas compressor of claim 1, further comprising at least one of a pressure sensor or a piston location sensor disposed in the first chamber and in communication with the controller.

4. The pneumatic gas compressor of claim 1, further comprising at least one of a pressure sensor or a piston location sensor disposed in the second chamber and in communication with the controller.

5. The pneumatic gas compressor of claim 1, wherein the vessel has a circular cross-sectional shape relative to the axis of piston motion, an elliptical cross-sectional shape, an oval cross-sectional shape, a stadium cross-sectional shape, a semicircular cross-sectional shape, a square cross-sectional shape, a rectangular cross-sectional shape, a triangular cross-sectional shape, or combination thereof.

6. The pneumatic gas compressor of claim 1, wherein the movable piston has a surface area between approximately 0.05 square inches and 102,000 square inches.

7. The pneumatic gas compressor of claim 1, wherein the first gas is substantially one of methane, natural gas, hydrogen, and ambient atmosphere.

8. The pneumatic gas compressor of claim 1, wherein the second gas is substantially one of methane, natural gas or hydrogen.

9. The pneumatic gas compressor of claim 1, wherein the second gas is from at least one of a gas well, an oil well or a combination oil and gas well.

10. The pneumatic gas compressor of claim 1, wherein the spring is disposed inside the first chamber.

11. The pneumatic gas compressor of claim 1, wherein the spring is disposed inside the second chamber.

12. The pneumatic gas compressor of claim 1, wherein the spring is disposed outside the vessel and in contact with a surface of the piston.

13. A method for compressing a first gas using a pneumatic gas compressor, the compressor comprising a vessel defining an interior volume, a movable piston disposed within the vessel dividing the interior volume into a first chamber and a second chamber, a spring disposed in contact with the piston to apply a biasing force, and a controller, the method comprising:
introducing a first gas at a varying pressure P_{F} with P_{FMAX}≥P_{F}≥P_{FMIN} from a first source into the first chamber through a first inlet valve;
introducing a second gas at a pressure P_{WELL} from a second source into the second chamber through a second inlet valve;
discharging a compressed gas from the first chamber through a first outlet valve into a discharge line at a pressure P_{SL};
discharging a compressed gas from the second chamber through a second outlet valve into the discharge line at a pressure P_{SL};
wherein P_{WELL}>P_{SL}>P_{FMAX}>P_{FMIN}, and the controller acts to cyclically actuate the inlet and outlet valves to compress and deliver the first gas and the second gas into the discharge line.

14. The method of claim 13, wherein the first gas is substantially one of methane, natural gas, hydrogen, and ambient atmosphere.

15. The method of claim 13, wherein the first gas is provided at a pressure between approximately 2,000 psi and approximately 20,000 psi.

16. The method of claim 13, wherein the second gas is substantially one of methane, natural gas and hydrogen.

17. The method of claim 13, wherein the second gas is from at least one of a gas well, an oil well or a combination oil and gas well.

18. The method of claim 13, wherein the movable piston has a surface area between approximately 0.05 square inches and 102,000 square inches.

19. The pneumatic gas compressor of claim 13, wherein the vessel has a circular cross-sectional shape relative to the axis of piston motion, an elliptical cross-sectional shape, an oval cross-sectional shape, a stadium cross-sectional shape, a semicircular cross-sectional shape, a square cross-sectional shape, a rectangular cross-sectional shape, a triangular cross-sectional shape, or combination thereof.

20. A pneumatic gas compressor, comprising:
a right-cylindrical vessel defining an interior volume;
a movable piston disposed inside the vessel, dividing the interior volume into a first chamber and a second chamber;
a spring disposed in the first chamber, in contact with the piston to apply a restoring force to the piston;
a first inlet disposed on the vessel in fluid communication with the first chamber, and a first inlet control valve coupled to the first inlet;
a first outlet disposed on the vessel in fluid communication with the first chamber, and a first outlet valve coupled to the first outlet;
a second inlet disposed on the vessel in fluid communication with the second chamber, and a second inlet control valve coupled to the second inlet;
a second outlet disposed on the vessel in fluid communication with the second chamber, and a second outlet control valve coupled to the second outlet; and
a controller in electrical communication with the first inlet control valve, the second inlet control valve, and the second outlet control valve, the controller configured to operate the valves;
wherein the first inlet control valve is fluidly connected to a first gas source at a varying pressure P_{F} where P_{FMAX}>P_{F}>P_{FMIN}, the second inlet control valve is fluidly connected to a second gas source at a pressure P_{WELL}, and the first and second outlet valves are fluidly connected to a discharge line at a pressure P_{SL}, wherein P_{WELL}>P_{SL}>P_{FMAX}>P_{FMIN}.
